(19) United States
(12) Patent Application Publication
(10) Pub. No.: US 2015/0170236 A1
(43) Pub. Date: Jun. 18, 2015

(54) SYSTEM AND METHOD FOR AUTHENTICATING AN AGENT

(71) Applicant: Avaya Inc., Basking Ridge, NJ (US)

(72) Inventors: Neil O'Connor, Galway (IE); Dawid Nowak, Dublin (IE); Tony McCormack, Galway (IE)

(73) Assignee: Avaya Inc., Basking Ridge, NJ (US)

(21) Appl. No.: 14/103,972

(22) Filed: Dec. 12, 2013

(51) Int. Cl. G06Q 30/06; H04L 29/06

(52) U.S. Cl. CPC G06Q 30/0609; H04L 63/08; H04L 63/083

(57) ABSTRACT

A system for authenticating an agent-initiated interaction between a customer and an agent is provided. A secure code generation module to generate a first secure code for an agent-initiated interaction between a customer and an agent and to provide the first secure code to an agent device; and a secure code verification module to receive a second secure code from an authentication device, determine whether the second secure code corresponds to the first secure code, and to provide an indication that the second secure code corresponds to the first secure code based on the determination that the second secure code corresponds to the first secure code or provide an indication that the second secure code does not correspond to the first secure code based on the determination that the second secure code does not correspond to the first secure code is disclosed.

### BACKGROUND

1. Technical Field

Embodiments of the present disclosure generally relate to a system and method for authenticating an agent. More specifically, embodiments of the present disclosure provide a system and method for a customer to authenticate an agent when the agent initiates an interaction with the customer.

2. Description of Related Art

Establishing trust between a caller and a called party is often necessary to efficiently transact business, convey information, or discuss confidential or private matters such that the called party feels comfortable sharing information with the caller. For example, when a customer calls a banking institution, the banking institution attempts to authenticate the customer (e.g., determine the customer is who they claim) prior to discussing the customer's banking information with them.

There are a variety of techniques that are available to authenticate a customer when they call into an organization. For example, the customer might be asked to verify information likely only known to the customer (e.g., social security number, address, account number, security word, pin number, or the like.) Accordingly, a customer may contact an organization to discuss matters related to the customer without having to resort to writing letters, personally visiting a physical location of the organization, or the like.

However, these authentication techniques are unsuitable for verifying the authenticity of an agent of the organization when the agent initiates an interaction with the customer (e.g., the agent calls the customer.) For example, when an agent of a banking institution calls a customer, the information used to authenticate the customer might be used to perpetrate various nefarious schemes (e.g., identity theft, phishing, or the like.) More specifically, a devious party, upon learning one piece of a customer's private information could call the customer and pretend to be the agent. The devious party might then seek to authenticate the interaction using the known piece of information. If the authentication is successful, the devious party could attempt to obtain more confidential and/or private information for purposes of furthering the nefarious scheme.

Thus, there is a need for a system and method for authenticating an agent of an organization when the agent initiates an interaction with a customer.

### SUMMARY

Embodiments in accordance with the present disclosure provide a system for authenticating an agent. With some examples, the system includes a secure code generation module to generate a first secure code for an agent-initiated interaction between a customer and an agent and to provide the first secure code to an agent device and a secure code verification module to receive a second secure code from an authentication device, determine whether the second secure code corresponds to the first secure code, and to provide an indication that the second secure code corresponds to the first secure code based on the determination that the second secure code corresponds to the first secure code or provide an indication that the second secure code does not correspond to the first secure code based on the determination that the second secure code does not correspond to the first secure code.

Embodiments in accordance with the present disclosure also provide a system for authenticating an agent-initiated interaction between an agent and a customer. With some examples, the system includes a secure code input module to receive a secure code and to provide the secure code to an authentication engine and a secure code validation module to receive an indication of the authentication of the secure code from the authentication engine.

Embodiments in accordance with the present disclosure also provide a computer-implemented method for authenticating an agent. With some examples, the method includes generating a first secure code for an agent-initiated interaction between a customer and an agent, providing the first secure code to an agent device, receiving a second secure code from an authentication device, determining whether the second secure code corresponds to the first secure code, and providing an indication that the second secure code corresponds to the first secure code based on the determination that the second secure code corresponds to the first secure code or providing an indication that the second secure code does not correspond to the first secure code based on the determination that the second secure code does not correspond to the first secure code.

Embodiments in accordance with the present disclosure also provide a computer-implemented method for authenticating an agent-initiated interaction between a customer and an agent. With some examples, the method includes receiving a secure code corresponding to the agent-initiated interaction, providing the secure code to an authentication engine, and receiving an indication of the authentication of the secure code from the authentication engine.

Embodiments in accordance with the present disclosure also provide a computer readable medium storing computer readable instructions when executed by a processor perform a method comprising generating a first secure code for an agent-initiated interaction between a customer and an agent, providing the first secure code to an agent device, receiving a second secure code from an authentication device, determining whether the second secure code corresponds to the first secure code, and providing an indication that the second secure code corresponds to the first secure code based on the determination that the second secure code corresponds to the first secure code or providing an indication that the second secure code does not correspond to the first secure code based on the determination that the second secure code does not correspond to the first secure code.

The present disclosure can provide a number of advantages depending on a particular configuration. First, embodiments of the present disclosure provide a mechanism that uses strategic Avaya Aura® and Avaya Experience Manager® contact center architecture to generate a secure key that may be used by a customer and an agent to authenticate an agent-initiated interaction between the customer and the agent. Avaya Aura® and Avaya Experience Manager® are core communication platforms supporting unified communications and contact center solutions for enterprises. Although Avaya® systems are used in this application for illustrative purposes, it should understood by one of ordinary skill in the art that any communications platform or for that matter contact center platform that supports customer-agent interaction and contact center solutions is contemplated by the present disclosure and that the Avaya® systems are used by way of example only and for simplicity of explaining embodiments of the present invention.

Furthermore, the present disclosure is applicable in any enterprise in addition to traditional contact center. Said differently, any enterprise where agents initiate interactions with customer and authentication of the interaction by the customer is desired may use embodiments of the present disclosure to facilitate the customer authenticating the agent-initiated interaction.

These and other advantages will be apparent from the following disclosure.

The preceding is a simplified summary of the present disclosure to provide an understanding of some aspects of various embodiments detailed herein. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing one or more of the features set forth above or described in detail below.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings, and wherein:

FIG. 1 is a block diagram depicting an illustrative computing system according to an embodiment of the present disclosure;

FIG. 2 is a block diagram of an authentication engine according to an embodiment of the present disclosure;

FIG. 3 is a flowchart of a method for authenticating an agent according to an embodiment of the present disclosure; and

FIG. 4 is a flowchart for a method for authenticating an agent according to an embodiment of the present disclosure.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “computer” or “computing device” as used herein should be understood to include any computing devices, such as, for example, a server, a workstation, a laptop, a tablet computer, smart phone, or otherwise any processor-based device configured to execute instructions.

The present disclosure will be illustrated below in conjunction with an exemplary computing system in the form of a contact center, e.g., the Avaya Aura® and/or Avaya Experience Manager® systems. Although well suited for use with, e.g., a computing system having contact processing hardware and/or software, the present disclosure is not limited to any particular type of system or configuration of system elements. Those skilled in the art will recognize the disclosed techniques may be used in any computing system in which it is desirable to authenticate agent-initiated interactions between customers and agents.

For example, the present disclosure may be applied to any of a variety of computing systems for interacting with customers on behalf of an organization. In particularly illustrative examples, the present disclosure may be implemented to provide that a customer, when interacting with an agent in an agent-initiated interaction, may authenticate the agent. Accordingly, although the present disclosure frequently refers to an example contact center, it is to be appreciated that this is not intended to be limiting and a computing system as described above may be substituted for the example contact center.

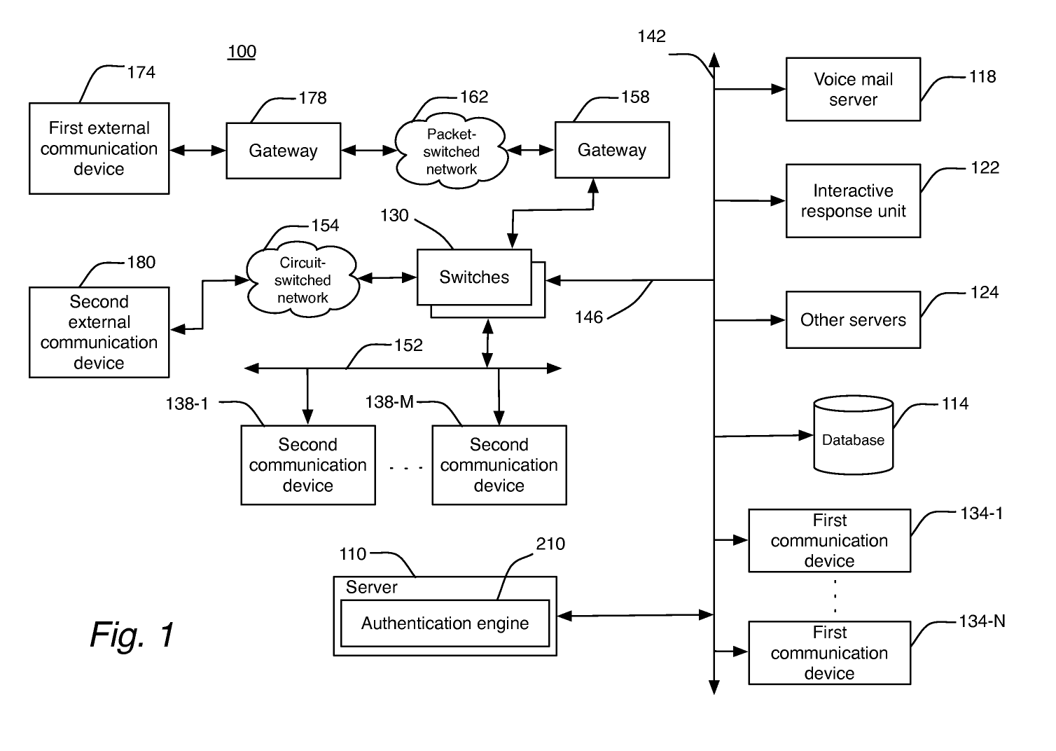

FIG. 1 shows an illustrative computing system in which the present disclosure may be implemented. The computing system is illustrated using an example contact center 100, which comprises a server 110 (described in greater detail below), a set of data stores or databases 114 containing contact or customer related information, agent information, secure code information, and/or other information that can enhance the value and efficiency of authenticating an agent initiating an interaction with a customer of the call center, and a plurality of computing resources (e.g., servers and/or communication devices) namely a voice mail server 118, an Interactive Response unit (e.g., IVR) 122, and other servers 124, switches 130, a combination of agents operating packet-switched (first) communication devices 134-1 to N (such as computer work stations or personal computers), and/or circuit-switched (second) communication devices 138-1 to M, all interconnected by a local area network LAN (or wide area network WAN) 142.

The components of the contact center 100 can be connected via optional communication lines 146 to the switches 130. As will be appreciated, the other servers 124 can also include a scanner (which is normally not connected to the switches 130 or Web server), VoIP software, video call software, voice messaging software, an IP voice server, a fax server, a web server, an email server, social networking servers, work request processing servers, and the like. The switches 130 are connected via a plurality of trunks to the Public Switch Telephone Network or PSTN 154 and via link(s) 152 to the second communication devices 138-1 to M. A gateway 158 is positioned between the switches 130 and the packet-switched network 162 to process communications passing between the switches 130 and the network 162.

As stated above, a combination of agents operate the first and second communication devices 134-1 to 134N and 138-1 to 138-M. During operation of the contact center 100, agents operating first communication devices 134-1 to N and/or second communication devices 138-1 to M engage in interactions with customers (e.g., customer interactions.) The customers may use first and second external communication devices 174 and 180 to interact with agents operating the first and second communication devices. It is to be appreciated, that the external communication devices are shown in a quantity to facilitate understanding and that in practice, more than two external communication devices will typically be provided. As such, the number of illustrated external communication devices is not intended to be limiting.

It is also to be appreciated that the contact center 100 may be used to facilitate customer interactions using a variety of types of communication, such as, for example, voice communications, email communications, text message communications, instant message communications, social network communications, or otherwise any communication where an organization desires to communicate with or otherwise interact with a customer.

Furthermore, it is to be appreciated, that the contact center 100 may allow customers to initiate contact with the contact center. However, as the present disclosure provides for customers being contacted by agents of the contact center 100 to authenticate the agents, interactions will be discussed in the context of originating from the contact center. More specifically, interactions between customer and agents, which are initiated by the agent, (e.g., agent-initiated interactions) are discussed. However, the term “agent-initiated interaction” may be interpreted to include interactions where the customer has previously requested to be contacted by the contact center. Said differently, an agent-initiated interaction may include an interaction where the agent contacts a customer to respond to a customer's prior request for contact. Examples are not limited in this context. As used herein, the term “agent” may include both live agents and interactive agents (e.g., automated interaction units, or the like.)

The switches 130 can be any architecture for establishing interactions between agents and customers. Illustratively, the switch and/or server can be a modified form of the subscriber-premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company.

Typically, the switches 130 and server 110 will be a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide the automatic monitoring assignment functionality described herein. Other types of known switches and servers are well known in the art and therefore not described in detail herein.

The server 110 can be any architecture for generating and verifying secure codes that may be used by a customer to authenticate an agent from the contact center 100. In general, the server 110 may generate a secure code, which the agent may provide to the customer. The customer may then validate this secure code (described in greater detail below) to authenticate the agent. Said differently, the customer may validate the secure code provided by the agent to provide assurances that the agent is calling from the contact center 100.

For example, a customer may be contacted on either the first or second external communication devices 174 or 180 by the contact center (e.g., by an agent operating the first communication devices 134-1 to 134-N, by an agent operating the second communication devices 138-1 to 138-M, or by the interactive response unit 122.) The agent may provide the customer with a secure code, which the customer may use to validate the authenticity of the agent. These and other examples will be described in greater detail below.

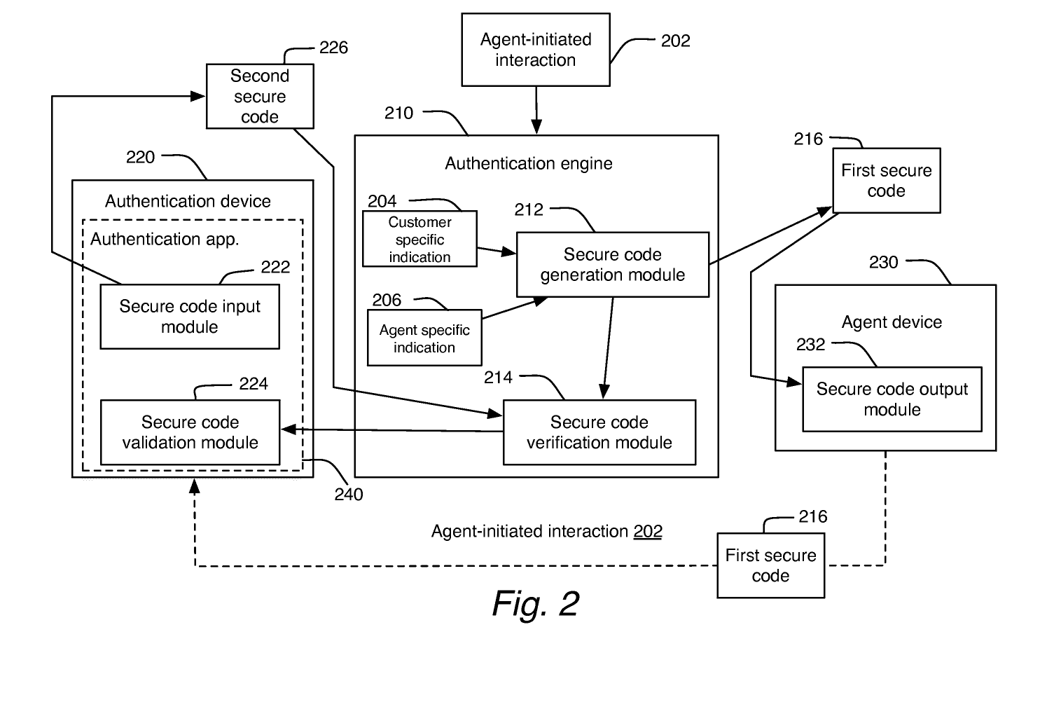

The server 110 includes an authentication engine 210 (explained in greater detail below with reference to FIG. 2) to facilitated authenticating an agent-initiated interaction between a customer and an agent of the contact center 100. Although this embodiment is discussed with reference to client-server architecture, it is to be understood that the principles of the present disclosure apply to other network architectures. For example, the present disclosure applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the invention does not require the presence of packet- or circuit-switched networks.

In some examples, the gateway 158 can be Avaya Inc.'s, G700 Media Gateway™ and may be implemented as hardware such as via an adjunct processor (as shown) or as a chip in the server.

In some examples, the first communication devices 134-1 to 134-N are packet-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

In some examples, the second communication devices 138-1 to 138-M are circuit-switched. Each of the communication devices 138-1 to 138-M corresponds to one of a set of internal extensions Ext1 to ExtM, respectively. The second communication devices can include, for example, wired and wireless telephones, PDAs, H.320 videophones and conferencing units, voice messaging and response units, traditional computer telephony adjuncts, and any other communication device.

It should be noted that the present disclosure does not require any particular type of information transport medium between a switch or server and first and second communication devices, i.e., the present invention may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with the external communication device 174 via a gateway 178; and the circuit-switched network 154 is in communication with the external communication device 180.

In one configuration, the central server 110, network 162, and first communication devices 134 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, communication devices, and other elements as shown in FIG. 1 is for purposes of illustration only and should not be construed as limiting the present disclosure and the foregoing claims to any particular arrangement of elements. Particularly, as stated, embodiments of the present disclosure may be implemented in a variety of different types of systems and is not limited to contact centers. Furthermore, the systems and methods described herein may be used to authenticate agents that are initiating interactions with customers for a variety of enterprises, industries, or endeavors. However, particularly illustrative examples may include authenticating agents from a banking institution, a financial institution, an employer, a health care provider, a technical support department or service, or otherwise any agent to which confidential and/or private information may be discussed, disclosed, communicated or otherwise made available to.

FIG. 2 illustrates an embodiment of the authentication engine 210. As depicted, the authentication engine 210 is configured to allow a customer to authenticate an agent-initiated interaction. In general, the authentication engine 210 is configured to generate a secure code and validate the secure code to authenticate an agent-initiated interaction between a customer and an agent. In operation, the authentication engine 210 may communicate with an authentication device 220 and an agent device 230. In general, the authentication device 220 and the agent device 230 may be a computing device as defined herein. As will be further explained below, a secure code may be generated by the authentication engine 210, provided to an agent (e.g., via the agent device 230), provided to a customer by the agent, received by the authentication device 220 and then authenticated using the authentication engine 210 in order to establish an amount of trust between the agent and the customer in an agent-initiated interaction. For example, for purposes of discussing confidential and/or private information.

With some examples, the authentication device 220 may correspond to the device used by the customer to interact with the agent (e.g., the first external communication device 174 or the second external communication device 180.) In some examples, the authentication device 220 may be a different device. For example, the customer may be interacting with the agent using the second external communication device 180 and the authentication device 220 may be a different device (e.g., the first external communication device 174, or the like,) which may be used to authenticate the agent-initiated interaction as described herein.

In some examples, the authentication device may be implemented in the contact center 100. For example, the authentication device may be an automated voice system (e.g., implemented in the IVR 122, or the like.) As another example, the authentication device 220 may be an Internet accessible website (e.g., secure banking website, healthcare account website, or the like) hosted on the other server 124. As another example, the authentication device 220 may be any computing device upon which an authentication application 240 may be executed. As a particularly illustrative example, the authentication device 220 may be a smartphone on which the authentication application 240 is installed and/or executable. It is noted, that although the authentication application 240 is depicted in FIG. 2, various examples may be implemented without the authentication application. For example, as stated, some examples may provide an interactive voice system to authenticate a caller. Examples are not limited in this context.

With some examples, the agent device 220 may correspond to the device used by the agent to interact with the customer (e.g., first communication devices 134-1 to 134-N or the second communication devices 138-1 to 138-M.) In some examples, the agent device may be a different device. For example, the agent may interact with the customer using the second communication device 138-1 and a different agent device 230 (e.g., the first communication device 134-1, or the like) to facilitate authentication as described herein.

The authentication engine 210 may include a secure code generation module 212, a secure code verification module 214. In operation, the authentication engine 210 may be configured to receive an indication of an agent-initiated interaction 202. For example, the engine 210 may be notified via LAN 142 of an outgoing customer contact by the communications component (e.g., switches 130, instant message server, text message server, web server, and/or other server) through which the agent-initiated interaction exits the contact center 100. Additionally, the engine 210 may receive and/or determine a customer specific indication 204 and an agent specific indication 206.

Furthermore, as introduced above, the present disclosure provides for an agent-initiated interaction (e.g., the agent initiated interaction 202) to be authenticated. Said differently, a customer (e.g., accessing the authentication device 220) may authenticate the agent-initiated interaction to be assured that the interaction is authentic (e.g., genuine.) Accordingly, the authentication engine 210 may generate a first secure code 216, which may be used to authenticate the agent-initiated interaction 202 as described more fully herein. The authentication device 220 may provide a second secure code 226 to the authentication engine 210. The authentication engine 210 may then determine a correspondence between the first and second secure codes 216 and 226 to determine if the agent-initiated interaction is authentic.

It is to be appreciated that the usage of the terms “first” and “second” is not meant to indicate first or second in time. Furthermore, it is to be appreciated, that the terms first and second are merely used to distinguish between the secure code as generated by the authentication engine 210 and the secure code as used by the authentication device 220 and the authentication engine 210 to authenticate the agent-initiated interaction 202. The following example is provided to more fully illustrate how the terms first and second are used herein. During operation, the authentication engine 210 may generate the first secure code 216 to facilitate authenticating the agent-initiated interaction 202. The first secure code 216 may be provided to the agent initiating the agent-initiated interaction (e.g., via the agent device 230). The agent may then provide the first secure code 216 to the customer through the interaction (e.g., through a telephone interaction, or the like). The customer may then use the authentication device 220 to authenticate the agent-initiated interaction 202 by inputting the code received from the agent (which, if the interaction is authentic will be the first secure code) into the authentication device 220. The authentication device 220 then provides this received secure code to the authentication engine 210 to authenticate the received code against the first secure code 216. The code received by the authentication device 220 and provided by the authentication device 220 to the authentication engine 210 may be referred to herein as the second secure code 226. As will be appreciated, typically, the first secure code 216 will be the same as the second secure code 226 as the secure code will have been generated, provide to the agent, provided to the customer by the agent, and used by the customer to authenticate the interaction. However, in the case of non-authentic interactions, the codes may be different. Said differently, a non-genuine agent may not know the first secure code and as such, may not be able to provide the first secure code to the customer. Accordingly, when the customer attempts to authenticate the agent-initiated interaction using the code, the authentication may fail. As such, the terms “first” and second” are used herein to distinguish between the secure code as generated by the authentication engine 210 and the secure code as provided to the authentication engine 210 by the authentication device 220. This example is not intended to be limiting, and it is to be appreciated, that the secure code may be referenced without the prefix “first” or “second.”

Turning more specifically to the operation of the authentication engine 210. The secure code generation module 212 may generate the first secure code 216 (e.g., for use in authenticating the agent-initiated interaction 202 as described herein.) With some examples, the secure code generation module 212 may generate the first secure code 216 based on a public key encryption scheme. With some examples, the first secure code 216 may change periodically. For example, the first secure code 216 may correspond to a periodically changing (e.g., every 60 seconds, every 120 seconds, every N, seconds, or the like) public key. In such examples, where multiple agent-initiated interactions exist (e.g., agent-initiated interactions 202-1 to 202-X,) the first secure code 216 may be the same for each agent-initiated interaction that is initiated within the same time period.

With some examples, the secure code generation module 212 may generate the first secure code 216 using a generation scheme (e.g., number, letter, character, alphanumeric, or the like.) With some examples, the first secure code 216 may be randomly generated. In such examples, where multiple agent-initiated interactions exist (e.g., agent-initiated interactions 202-1 to 202-X,) the secure code generation module 212 may generate a different first secure code 216 for each agent-initiated interaction 202-x.

In some examples, the first secure code 216 may be generated based on a customer specific indication 204 and/or an agent specific indication 206. More specifically, the authentication engine 210 may be configured to receive and/or determine the customer specific indication 204 and/or the agent specific indication 206. With some examples, the customer specific indication 204 may include a customer name, a customer nickname, a customer identification, customer contact information (e.g., cell phone, email, mailing address, or the like,) a customer specific passphrase, a customer specific pin, or the like. In some examples, the agent specific indication 206 may include an agent name, agent identification, or the like.

The secure code generation module 212 may then use one or more of the customer specific indications, agent specific indications, and/or portions thereof to generate the secure key. For example, for a customer named “John Smith,” the secure code generation module 212 may generate the secure code “1234SmithJ.”

The secure code generation module 212 is configured to provide the first secure code 216 to the agent device 230. The agent device 230 includes a secure code output module 232 for providing the first secure code 216 to the agent. For example, where the agent is a live agent, the agent device may be a computing device associated with the agent and the secure code output module 232 may be an application executing on the computing device to display the first secure code 216. As such, the agent device (and the agent) may receive the first secure code 216. The agent may then provide the first secure code 216 to the customer through the agent-initiated interaction. For example, if the agent called the customer, the agent may provide the secure code via the call.

In some examples, as stated, the agent may be an interactive agent. As such, the agent device may correspond to an interactive agent server (e.g., the IVR 122, or the like). The secure code output module 232 may receive the secure code and provide the secure code to the customer. For example, the module 232 may include a text to speech application to audibility output the first secure code 216 for the customer.

In some examples, it may be advantageous to use an automated voice system to establish the agent-initiated interaction and facilitated the customer authenticating the interaction. After which, the interaction may be passed to a live agent.

It is important to note, that the first secure code 216 is shown being provided from the agent device 230 to the authentication device 220 over the agent initiated interaction 202 (dashed line) for illustrative purposes only. As described above, the agent-initiated interaction may be done using a variety of combinations of devices, which may not necessarily correspond to the agent device 230 and the authentication device 220. However, providing the first secure code from the agent to the customer is done to more fully illustrate how the customer may receive the first secure code 216 and authenticate the agent-initiated interaction 202 using the code.

The secure code verification module 214 is configured to receive the second secure code 226 from the authentication device 220. Furthermore, the secure code verification module 214 is configured to determine whether the second secure code 226 corresponds to the first secure code 216. Said differently, the module 214 determines if the second secure code 226 (e.g., the secure code received from the customer) corresponds to the first secure code 216 (e.g., the secure code provided to the agent.) With some examples, the second secure code 226 may correspond to the first secure code 216 if the secure codes are the same.

The secure code verification module 214 may further be configured to provide an indication that the second secure code 226 corresponds to the first secure code 216 based on the determination that the second secure code 226 corresponds to the first secure code 216. Additionally, the secure code verification module 214 may be configured to provide an indication that the second secure code 226 does not correspond to the first secure code 216 based on the determination that the second secure code 226 does not correspond to the first secure code 226. With some examples, the indication is provided to the authentication device 220. More specifically, the indication is provided to the authentication application 240, or more particularly, the secure code validation module 224.

Turning more specifically to the operation of the authentication device 220. The authentication device includes the authentication application 240, which has a secure code input module 222 and a secure code validation module 224. With some examples, the authentication application 240 may be an application provided by the entity associated with the agent. For example, if the agent is a banking institution agent, the authentication application 240 may be an application for accessing the banking institution (e.g., a computer executable application, a secure website, a automated voice response system, or the like.) As a particularly illustrative example, a agent-initiated interaction with an agent of a banking institution is envisioned. The authentication application 240 may be an “app” (e.g., a smartphone, tablet, or the like) with which the customer accesses mobile banking services (e.g., checks account balances, performs balance transfers, deposits checks, or the like.) The present disclosure may be implemented in such an application. For example, the application may include the secure code input module 222 and the secure code validation module 224 to allow the customer to authenticate the agent-initiated interaction.

The secure code input module 222 is configured to receive a secure code (e.g., referred to herein as the second secure code 226.) For example, the customer, when provided the first secure code 216 by agent may then provide the secure code to the secure code input module 222. As such, the module 222 may receive the second secure code 226 (which may correspond to the first secure code 216) from the customer. The secure code input module 222 may provide the second secure code 226 to the authentication engine 210. More specifically, the secure code input module 222 may provide the second secure code 226 to the secure code verification module 214.

The secure code validation module 224 is configured to receive an indication of the authentication of the second secure code 226 from the authentication engine 210. Said differently, the secure code validation module 224 may receive an indication that the agent-initiated interaction is authentic or not authentic. The secure code validation module 224 may also be configured to provide an indication to the customer that the agent-initiated interaction is authentic or not authentic.

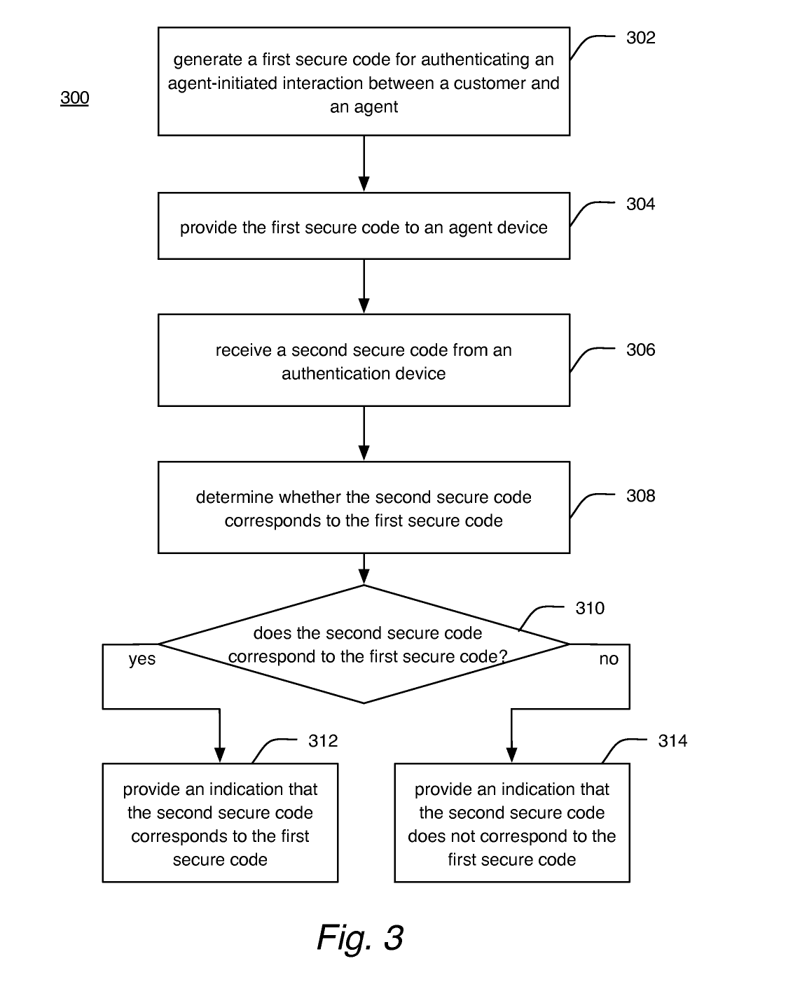

FIG. 3 is a flowchart of a method 300 for authenticating an agent initiating an interaction with a customer. Although the method 300 is described with reference to the engine 210 and the contact center 100, this is not intended to be limiting. At block 302, generate a first secure code for authenticating an agent-initiated interaction between a customer and an agent; the secure code generation module 212 may generate the first secure code 216.

At block 304, provide the first secure code to an agent device; the secure code generation module 212 may provide the first secure code 216 to the agent device 230. With some examples, the secure code generation module 212 may provide the first secure code 216 to the secure code output module 232.

At block 306, receive a second secure code from an authentication device; the secure code verification module 214 may receive the second secure code 226 from the authentication device 220. With some examples, the secure code verification module 214 may receive the second secure code 226 from the secure code input module 222.

At block 308, determine whether the second secure code corresponds to the first secure code; the secure code verification module 214 may determine if the second secure code 226 corresponds to the first secure code 216.

The method 300 may include decision 310, does the second secure code correspond to the first secure code.

At block 312, provide an indication that the second secure code corresponds to the first secure code; the secure code verification module 214 may provide an indication to the authentication device 220 that the second secure code 226 corresponds to the first secure code 216 if it is determined that the secure codes correspond to each other (e.g., at block 308 and decision 310.)

At block 314, provide an indication that the second secure code does not correspond to the first secure code; the secure code verification module 214 may provide an indication to the authentication device 220 that the second secure code 226 does not correspond to the first secure code 216 if it is determined that the secure codes do not correspond to each other (e.g., at block 308 and decision 310.)

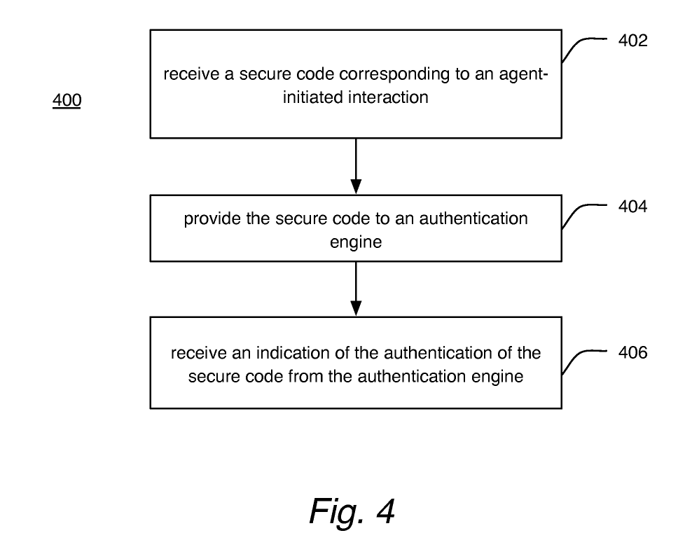

FIG. 4 is a flowchart of a method 400 for authenticating an agent-initiated interaction between a customer and an agent. Although the method 400 is described with reference to the authentication device 220 and the authentication application 240, this is not intended to be limiting. At block 402, receive a secure code corresponding to the agent-initiated interaction; the secure code input module 222 may receive the second secure code 226.

At block 404, provide the secure code to an authentication engine; the secure code input module 222 may provide the second secure code 226 to the authentication engine. With some examples, the secure code input module 222 may provide the second secure code 226 to the secure code verification module 214.

At block 406, receive an indication of the authentication of the secure code from the authentication engine; the secure code validation module 224 may receive an indication from the authentication engine 210 that the second secure code 226 is authentic or not authentic.

Accordingly, various systems and methods for a customer to authenticate an agent-initiated interaction are provided. The exemplary systems and methods of this present disclosure have been described in relation to a contact center. However, to avoid unnecessarily obscuring the present disclosure, the preceding description omits a number of known structures and devices. This omission is not to be construed as a limitation of the scope foregoing claims. Specific details are set forth to provide an understanding of the present disclosure. It should however be appreciated that the present disclosure may be practiced in a variety of ways beyond the specific detail set forth herein.

Furthermore, while the exemplary embodiments of the present disclosure illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for authenticating an agent, the system comprising:
a secure code generation module to generate a first secure code for an agent-initiated interaction between a customer and an agent and to provide the first secure code to an agent device; and
a secure code verification module to receive a second secure code from an authentication device, determine whether the second secure code corresponds to the first secure code, and to provide an indication that the second secure code corresponds to the first secure code based on the determination that the second secure code corresponds to the first secure code or provide an indication that the second secure code does not correspond to the first secure code based on the determination that the second secure code does not correspond to the first secure code.

2. The system of claim 1, determining whether the second secure code corresponds to the first secure code includes determining if the first secure code is the same as the second secure code.

3. The system of claim 1, the indication that the second secure code corresponds to the first secure code including an indication that the agent-initiated interaction is authentic.

4. The system of claim 1, the indication that the second secure code does not correspond to the first secure code including an indication that the agent-initiated interaction is not authentic.

5. The system of claim 1, the secure code generation module to generate the first secure code based at least in part on a public key encryption scheme or a random scheme.

6. The system of claim 1, the secure code generation module to receive a customer specific indication corresponding to the customer, the secure code generation module to generate the first secure code based at least in part on the customer specific indication.

7. The system of claim 6, wherein the customer specific information is selected from the group consisting of customer name, customer nickname, customer identification, customer contact information, customer specific passphrase, or customer specific pin.

8. The system of claim 1, the secure code generation module to receive an agent specific indication corresponding to the agent, the secure code generation module to generate the first secure code based at least in part on the agent specific indication.

9. The system of claim 8, wherein the agent specific indication is selected from the group consisting of an agent name, or an agent identification.

10. A system for authenticating an agent-initiated interaction between an agent and a customer, the system comprising:
a secure code input module to receive a secure code corresponding to an agent-initiated interaction and to provide the secure code to an authentication engine; and
a secure code validation module to receive an indication of the authentication of the secure code from the authentication engine.

11. The system of claim 10, the indication of the authentication including an indication that the agent-initiated interaction is authentic.

12. The system of claim 10, the indication of the authentication including an indication that the agent-initiated interaction is not authentic.

13. A computer-implemented method for authenticating an agent, the method comprising:
generating a first secure code for authenticating an agent-initiated interaction between a customer and an agent;
providing the first secure code to an agent device;
receiving a second secure code from an authentication device;
determining whether the second secure code corresponds to the first secure code; and
providing an indication that the second secure code corresponds to the first secure code based on the determination that the second secure code corresponds to the first secure code or providing an indication that the second secure code does not correspond to the first secure code based on the determination that the second secure code does not correspond to the first secure code.

14. The computer-implemented method of claim 13, the indication that the second secure code corresponds to the first secure code including an indication that the agent-initiated interaction is authentic.

15. The computer-implemented method of claim 13, the indication that the second secure code does not correspond to the first secure code including an indication that the agent-initiated interaction is not authentic.

16. The computer-implemented method of claim 13, wherein generating the first secure code is based at least in part on a public key encryption scheme or a random scheme.

17. The computer-implemented method of claim 16, wherein generating the first secure is based at least in part on a time interval for generating secure codes.

18. The computer-implemented method of claim 13, wherein receiving a second secure code from an authentication device includes receiving the second secure code from an application executing on the authentication device.

19. The computer-implemented method of claim 18, wherein providing the indication that the second secure code corresponds to the first secure code includes providing the indication to the application executing on the authentication device.

20. The computer-implemented method of claim 18, wherein providing the indication that the second secure code does not correspond to the first secure code includes providing the indication to the application executing on the authentication device.

21. A computer-implemented method for authenticating an agent-initiated interaction between a customer and an agent, the method comprising:
receiving a secure code corresponding to the agent-initiated interaction;
providing the secure code to an authentication engine; and
receiving an indication of the authentication of the secure code from the authentication engine.

22. The computer-implemented method of claim 21, the indication of the authentication including an indication that the agent-initiated interaction is authentic.

23. The computer-implemented method of claim 21, the indication of the authentication including an indication that the agent-initiated interaction is not authentic.
